(19) United States
(12) Patent Application Publication
(10) Pub. No.: US 2008/0024311 A1
(43) Pub. Date: Jan. 31, 2008

(54) INFANT MONITORING SYSTEM

(76) Inventor: Kay Mann, Powhatan, VA (US)

Correspondence Address: ADVANTIA LAW GROUP, 9035 SOUTH 1300 EAST, SUITE 200, SANDY, UT, 84094, US

(21) Appl. No.: 11/829,839

(22) Filed: Jul. 27, 2007

Related U.S. Application Data
(60) Provisional application No. 60/820,568, filed on Jul. 27, 2006.

(51) Int. Cl. G08B 23/00

(52) U.S. Cl. 340/573.1

(57) ABSTRACT

An infant monitoring system, comprising: a blanket member having a pressure sensor array in an arcuate shape; a speaker module; a control module to control the relay of signals; a remote alert module for audio and vibratory alerts; and a relay module, in communication with the control module, remote alert module and a user. The blanket member has multiple layers. The pressure sensor array includes at least one pressure sensor disposed in a fluid filled member for registering pressure differentials applied thereto. There is a multiplicity of pressure sensor arrays inside the blanket member; the multiplicity of pressure sensor arrays is formed in concentric arcuate shapes proximate to each other. The pressure sensor array is curved so as to define a top half of a body outline. The pressure sensor array has a material disposed around it to form a semi-tubular shape to keep an infant in a proper position.

### CROSS-REFERENCE TO RELATED APPLICATIONS

This invention claims priority, under 35 U.S.C. §120, to the U.S. Provisional Patent Application No. 60/820,568 to Kay Mann filed on Jul. 27^{th} 2006, which is incorporated by reference herein.

### FIELD OF THE INVENTION

The present invention relates to monitoring systems, specifically to infant monitoring systems.

### DESCRIPTION OF THE RELATED ART

In the related art there are systems for monitoring infants to determine their position and/or location to prevent the occurrence of bodily harm to the infants. There is a cause of death known as Sudden Infant Death Syndrome (SIDS) which is the cause of death for many infants each year. An infants' position may be a major contributing factor in deaths attributed to SIDS. It is posited that if an infant becomes positioned in the prone position they may suffocate. Due to various necessities of a caretaker's life it may not be possible for a caretaker to constantly monitor an infant, thereby preventing positioning of the infant that may be dangerous. Caretakers of infants may need to leave an infant unattended. Therefore there is a need for a system that effectively and conveniently monitors an infant's position such that a caretaker may be remotely alerted when the infant moves to an undesired position. Some improvements have been made in the field. Examples of references related to the present invention are described below, and the supported teachings of each reference are incorporated by reference herein:

U.S. Pat. No. 5,774,055, issued to Pomerantz, discloses an infant monitoring device includes a sensor connected to an alarm for alerting a parent when an infant is in a predetermined position. In a second embodiment, the alarm is activated only if the same body position is detected by the sensor for the duration of a delay determined by a timer. In a third embodiment, a wireless transmitter is connected to the sensor for communicating with a wireless receiver and activating a remote alarm. In a fourth embodiment, a timer is connected between the sensor and the wireless transmitter to reduce false alarms. In a fifth embodiment, a plurality of sensors are connected to a multi-channel wireless transmitter for sensing a plurality of positions, and communicating with a multi-channel wireless receiver for activating a remote alarm. In a sixth embodiment, a timer is connected between the sensors and the multi-channel transmitter for reducing false alarms. In all embodiments, the sensor may be a disc-shaped or spherical mercury switch with one or more pairs of electrodes for detecting one or a plurality of positions, or the sensor may be a hollow housing with a pendulum arm making contact with electrodes on the interior thereof.

U.S. Pat. No. 5,081,447, issued to Echols, discloses an apparatus for influencing a person preferentially to sleep on his side and not on his back. A gravity actuated sensor apparatus is attached to a sleeping person for detecting body position and to sound an alarm informing the person when he is resting on his back; thereby enticing the person to sleep on one side or the other and not on his back. Appropriate circuitry connects the sensor apparatus and alarm so that the alarm is actuated in response to the sensor apparatus detecting an undesirable body position. The sensor apparatus is positioned on one's head, or alternatively, is positioned on one's body. The alarm can be sensed by a sleeper to thereby induce the sleeper to move to an alternate position whenever he attempts to rest on his back for more than a few seconds.

U.S. Pat. No. 4,884,067, issued to Nordholm, et al., discloses a personal security communication system is disclosed. It is comprised of a motion and position sensor adapted to detect motion and lack of motion. The sensor has a motion and position sensing switch having means indicative of the motion of a contact making element in the switch and is adapted to provide at least a first and second electrical state according to the motion and lack of motion of the contact making element. Means is provided for detecting the first and second electrical state. The detecting means being adapted to provide a signal indicative of the electrical state of said switch. The system also includes user input means, processor means for receiving information from said motion sensing means and said user input means and adapted to format a digital data message indicative of said information, a transmitter means for transmitting said message, an alarm means activatable by said processor means and a power supply means for powering said processor means, transmitter and alarm means.

U.S. Pat. No. 5,241,300, issued to Buschmann, discloses a transilluminated optical fiber is placed adjacent to an infant's respiratory moving parts using an elastic fabric. Use is made of the effect that moving the fiber causes a modulation of the intensity of the transmitted light to monitor the infant's breathing pattern to avoid S(udden) I(nfant) D(eath) S(yndrome).

U.S. Pat. No. 5,914,660, issued to Mesibov, et al., discloses a device for reducing the possibility of sudden infant death syndrome (SIDS) comprises a position-indicating device effectively coupled to a signal-producing circuit and attached to the clothing of the infant. The position-indicating device provides signals varying in response to prone and other positions assumed by the infant during sleep, allowing an associated alarm device to be activated in response to the infant's assuming a SIDS-dangerous prone or side-lying position. In one embodiment, the position of the infant can be determined by an optical sensor interacting with a reflective or other marker adhered to the infant. Gravity or pressure switches may also be used to provide position-responsive signals. A signal generated upon assumption of the SIDS-dangerous prone or side-lying positions is transmitted to a remote receiver located proximate the infant's care-giver whereupon an alarm is generated to indicate the need to reposition the infant. A constant low-level or intermittent maintenance signal can be produced to assure the continued and proper operation of the apparatus. An additional awakening alarm can be produced near the sleeping infant to further reduce the likelihood of a SIDS event.

U.S. Pat. No. 5,515,865, issued to Scanlon, discloses a movement and sound monitor and stimulator which is particularly useful for preventing death in human infants from sudden infant death syndrome is disclosed. The movement and sound monitor and stimulator has a base member which may be a fluid-filled sensing pad for supporting the infant or other animate object which is being monitored and a transducer positioned for detecting movement or acoustic activity (e.g., heartbeat, breathing) of the object on the base member to provide an output signal in response to forces applied thereto which are generated by such movement. A circuit is connected to monitor the output signal from the transducer and activates a stimulator which is operable to provide movement to the base member to stimulate movement in the object when output from the transducer to the circuit corresponds to no movement from the object. The transducer may be a pressure transducer in fluid communication with the fluid interior of the sensing pad. In the alternative, a piezo-electric sheet operatively connected to a surface of the sensing pad to detect such movement as well as movement cessation. The circuit may also be connected to an alarm which can provide an audible or visual indication to third parties when there is no movement from the object.

U.S. Pat. No. 6,765,489, issued to Ketelhohn, discloses a device for use with an infant that provides audible or visual signals based on a sensed lack of motion from an infant to stimulate motion by the infant. The sounds or light generated by the device are designed to encourage movement in an infant that is not moving, in order to reinitiate spontaneous movement by the infant and to alert a caregiver as to lack of movement by the infant. The device can also be configured to provide different audible sounds for different movements that are sensed by the device. The motion is sensed by an accelerometer disposed within the device that is formed of a monolithic integrated circuit chip. The accelerometer is connected to a controller that analyzes the accelerometer output signals and controls the sound or lights of the device in response to the accelerometer signals.

U.S. Pat. No. 6,057,767, issued to Barnoach, discloses to an apparatus for preventing snoring and for alerting when an infant sleeps on his back. The apparatus for preventing snoring is comprised of a gravity actuated sensor, a delay time circuit and a vibrator, which are placed within a housing. The apparatus is worn by its user, and the gravity activated sensor senses when it is in a predetermined range of deviation from the horizontal, and sends a detect signal to the time delay circuit. If the detect circuit lasts for a longer period than a predetermined interval, the delay time circuit activates a vibrator which irritates the apparatus user, causes him to change his sleep posture, without waking him. The apparatus for alerting when an infant sleeps on his back is comprised of two parts. The first part is comprised of a gravity actuated sensor, a delay time circuit and a transmitter, which are placed within a housing. The first part is analogous to apparatus for preventing snoring but has a transmitter instead of vibrator. The transmitter sends a signal to the second part of the apparatus, which is worn by another person. The receiver activates a vibrator which awakens the other person.

U.S. Pat. No. 6,377,177, issued to Broussard, et al., discloses a baby blanket with baby monitoring system for monitoring the weight of a baby. The baby blanket with baby monitoring system includes a blanket that has a weight sensor positioned in an interior of the blanket. The weight sensor is adapted for measuring a weight of an object resting on the blanket. A control unit that has a microcontroller is operationally coupled to the weight sensor. The control unit also has a main audio alarm. The main audio alarm is operationally coupled to the microcontroller. The microcontroller activates the main audio alarm upon the weight sensor sensing a weight outside of a pre-selected range of weight values. In addition, a remote unit can be used to monitor the weight sensor at a distance.

U.S. Pat. No. 6,468,234, issued to Van der Loos, et al., discloses a method and apparatus for measuring sleep quality that utilizes sensors incorporated in a sheet which is laid on top of a conventional mattress on which the subject sleeps. The sensors can collect information such as the subject's position, temperature, sound/vibration/movement, and optionally other physical properties. The apparatus for monitoring an individual's sleep quality is comprised of one or more layers of arrays of integrated sensors, which can be incorporated in layer pads, which is then placed on a conventional mattress; one or more controllers coupled with the arrays of integrated sensors in each layer pad for the purpose of acquiring data from the sensors; a real-time analysis software for analyzing data acquired by the controller from the array of integrated sensors; an interface software for collecting user lifestyle data; a lifestyle correlation software for correlating the lifestyle data with the data acquired by said array of sensors; one or more active components to improve sleep quality based on the data acquired through the sensors and the lifestyle data. The array of sensors provide one or more of the following data: position, temperature, sound, vibration, and movement data. Each layer pad can be individually removed or added as necessary depending on the data being collected.

U.S. Pat. No. 6,485,441, issued to Woodward, discloses a mattress device provides a high information variety from a low number of sensors configured and placed in correspondence with a mattress core layer and a mattress top layer of the mattress device in order to monitor a patient's sleep behavior. Mattress core and top layers provide a static position transmission characteristic and a dynamic impulse transmission characteristic enabling the sensors to recognize body imprint position and body impulses induced by the sleeping patient with a broad bandwidth. In an alternate embodiment, the mattress device may be combined with a signal coder capable of receiving signals or signal components from the sensors and transform them in an analog signal that can be received and processed by a conventional sound card of a computer. A decoding program installed on the computer decodes the alphanumeric information processed from the analog signal by the sound card and makes it available for further interpretation.

U.S. Pat. No. 5,684,460, issued to Scanlon, discloses a movement monitor and stimulator may prevent death in human infants from sudden infant death syndrome (SIDS). Recent medical studies indicate a SIDS victim's breathing may be resuscitated by immediate stimulation. The sound and/or movement monitor and stimulator may have a base member configured as a fluid-filled sensing pad for supporting an infant and a transducer for detecting movement or acoustic activity (e.g., heart beat, breathing, voice and motion sounds). A stimulator may move the base member to stimulate movement in the object when output from the transducer corresponds to no sound and/or movement from the object, or indicates a dangerous change in monitored condition, such as the decrease in metabolic rate indicative of the onset of sleep. The stimulator may also be applied in a more gentle fashion to soothe and quiet an infant that has been awakened unexpectedly. The transducer may be a pressure transducer in fluid communication with the fluid interior of the sensing pad. Alternatively, a piezoelectric sheet operatively connected to a surface of the sensing pad may detect movement and movement cessation. An alarm may provide an audible and/or visual indication to third parties when there is no movement from the object. A transmitter may continuously transmit the sensor's output to a remote location for monitoring. A remote monitor may transmit heart and breathing sounds and may also have lights indicating motion and acoustic activity to indicate the infant is breathing.

The inventions heretofore known suffer from a number of disadvantages, which include being: expensive, overly complicated, limited in use, limited in adaptability, excessively large, uncomfortable for the user and/or otherwise fails to provide a safe, efficient, and/or effective means for monitoring an infants position to help prevent SIDS. Accordingly, what is needed is a infant monitoring system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available infant monitoring systems. Accordingly, the present invention has been developed to provide an infant monitoring system.

There is an infant monitoring system which may include: a blanket member which may have: a pressure sensor array in an arcuate shape, which may be disposed interior to the blanket member, and/or may be configured to measure and/or communicate pressure measurements; there may be a speaker module, configured to emit audio communication; there may also be a control module, in electronic communication with the pressure sensor array, and/or the speaker module, and/or may be configured to control the relay of electronic and/or wireless signals therefrom; there may also be a remote alert module, which may be configured to provide audio and/or vibratory alerts; and/or a relay module, in wireless communication with the control module and/or the remote alert module, and/or may be disposed proximate to the blanket member and/or be configured to receive and/or send wireless communication with other modules and may relay audio alerts to a user.

The blanket member of the system may further be comprised of multiple layers wherebetween the pressure sensor array is disposed. The infant monitoring system which may include pressure sensor array may further include at least one pressure sensor disposed in a fluid filled member so that a pressure differential may be registered when pressure is applied anywhere upon the fluid filled member. Additionally, there may be a multiplicity of pressure sensor arrays which may be disposed interior to the blanket member, wherein the multiplicity of pressure sensor arrays may be formed in concentric arcuate shapes proximate to each other. Moreover, the arcuate shape formed which may be formed by the pressure sensor array may be curved so as to define the form of a top half of a body outline. Additionally, the pressure sensor array may have a material disposed around it which may form a semi-tubular shape, wherein the semi-tubular shape may serve to further keep an infant in a proper position.

The infant monitoring system which may include the control module wherein the control module may further include: an On/Off switch; a data processing module which may be configured to process signals received from the pressure sensor array; a transceiver module which may be configured to send wireless signals to the relay module; and/or a power module which may be configured to provide power to all components requiring power which may be in electric communication with the control module.

The infant monitoring system which may include the relay module which may further include a relay speaker module configured to communicate audio messages to a user. Further, the remote alert module may further include a vibrating module, configured to communicate a vibratory alert to a user. Moreover the remote alert module may further include a remote speaker module configured to communicate an audio message to a user.

The power module of the infant monitoring system may further comprise a power cord for connecting to a power source which may include a power outlet. Further, the remote alert module may further include a remote power module in electric communication therewith configured to power the remote alert module. Moreover, the remote power module may further include a least one battery wherein the battery is rechargeable by a recharging module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a top perspective view of an infant monitoring system, according to one embodiment of the invention;

FIG. 2 is a top perspective view of an infant monitoring system, according to an alternative embodiment of the invention;

FIG. 3 is a top perspective view of an infant monitoring system, according to an alternative embodiment of the invention;

FIG. 4 is a block diagram of an infant monitoring system according to one embodiment of the invention;

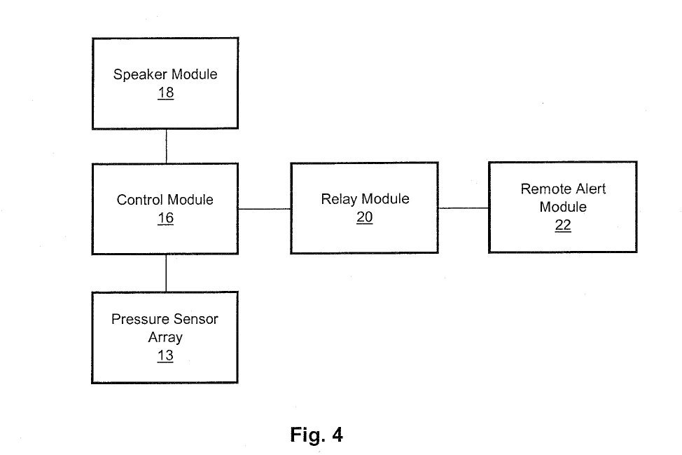

FIG. 5 is a block diagram of control module of an infant monitoring system according to one embodiment of the invention;

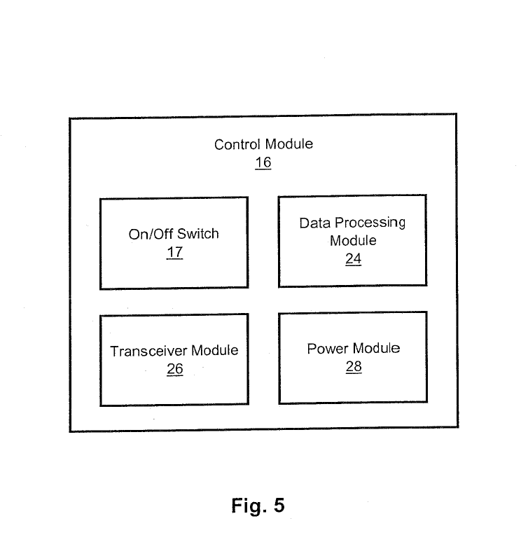

FIG. 6 is a block diagram of a relay module of an infant monitoring system according to one embodiment of the invention; and

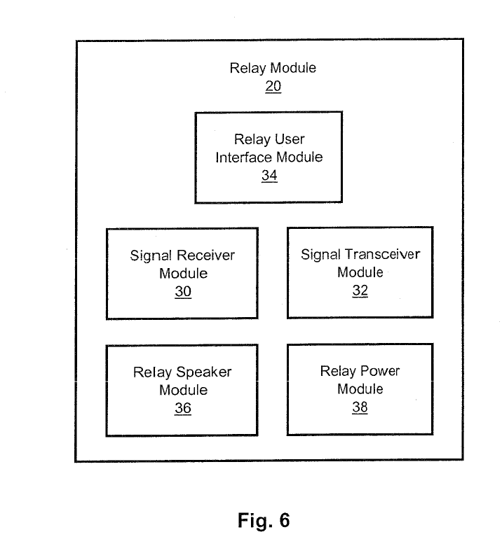

FIG. 7 is a block diagram of a remote alert module of an infant monitoring system according to one embodiment of the invention.

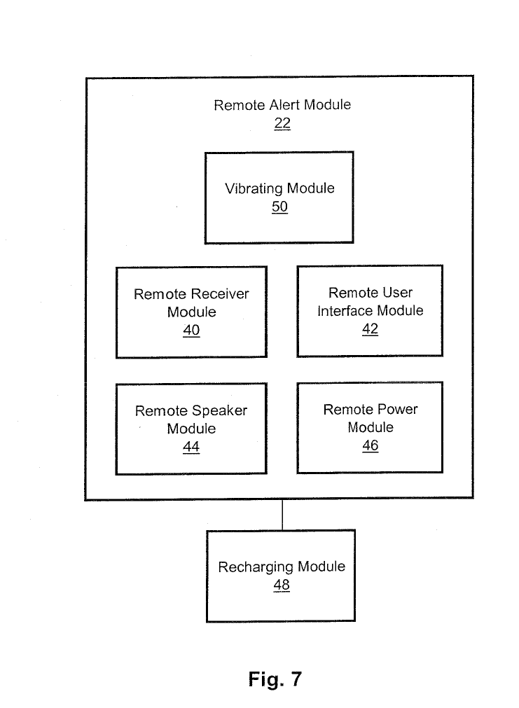

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one, skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

The figures illustrate one or more embodiments of an infant monitoring system, and in conjunction with the detailed description, the invention is disclosed.

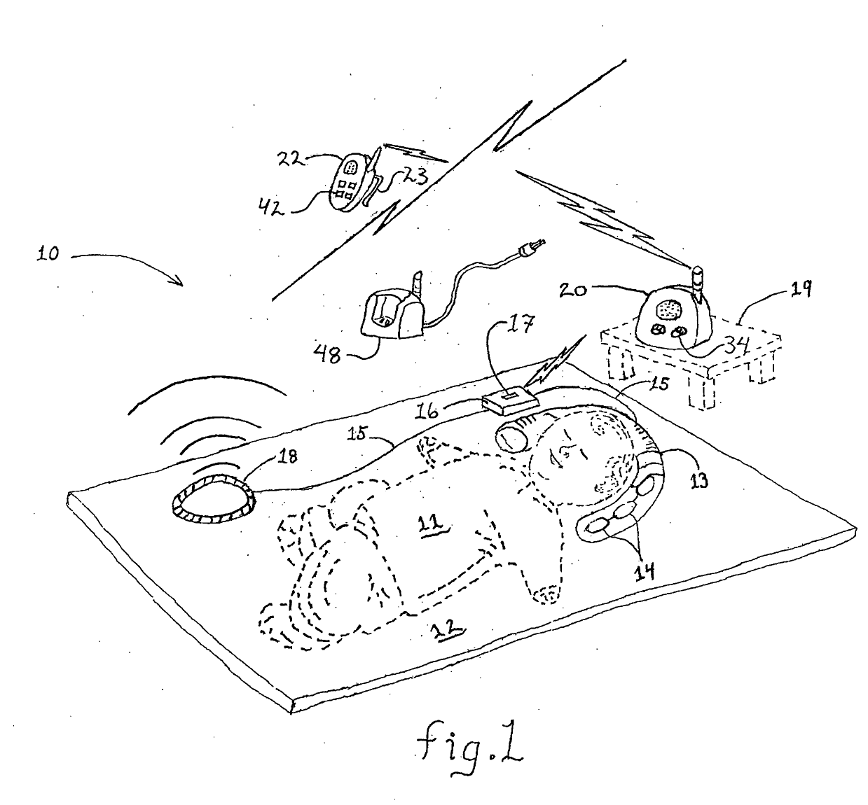

FIG. 1 illustrates a top perspective view of an infant monitoring system 10, according to one embodiment of the invention. The shape of an infant 11 is shown to provide reference as to how an infant may be oriented with respect to the infant monitoring system 10. Shown 10, there is a blanket member 12 wherein certain components are integrated, including; a pressure sensor array 13, a control module 16, and a speaker module 18. The blanket member 12 may have a thickness comprising multiple layers wherebetween the aforementioned components are disposed. In one embodiment, the multi-layer construction of the blanket member 12 provides for the pressure sensor array 13, the speaker module 18 and the control module 16 to be disposed between the layers thereof. The blanket member 12 is coupled at edges thereof and around the components so as to hold the components 13, 16, and 18 in place between the layers thereof. The layers of the blanket may be sewn together, glued, stapled and/or coupled by any other appreciated method for binding layers of material together in the art. In one embodiment the blanket member is composed of a soft, compliant and padded-type material. For example, the blanket member may be composed of material such as, but not limited to: cotton, polyester, rayon, nylon, and silk.

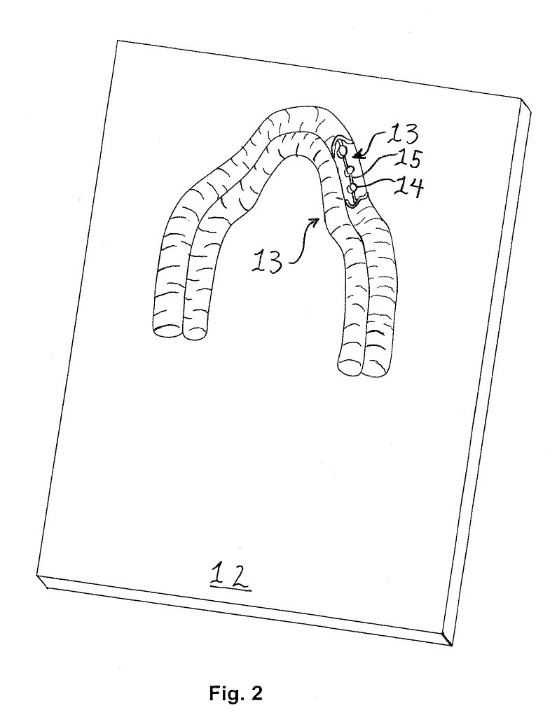

As shown, a pressure sensor array 13 is formed in an arcuate shape fixably attached between the layers of the blanket member 12. In one embodiment, the pressure sensor array 13 is a series of pressure sensors configured together to measure pressure differentials proximate to the sensors and electronically communicate the magnitude of the measured pressure differential to the control module 16. Ilustrated in FIG. 2, according to one embodiment of the invention, the pressure sensor array is arranged in an arched shape so as to define a silhouette of an upper portion of a human body outline. As illustrated, the pressure sensor array 13 is disposed close to a proximal end of the blanket member 12, such that the apex of the arcuate shape thereof is near the proximal end of the blanket member 12. Additionally, the pressure sensor array 13 is disposed centrally side-to-side in the blanket member 12. As illustrated, the pressure sensor array 13 is shaped so as to be proximate to, and surround on, three sides of the infant's 11 head.

Further, the pressure sensor array 13 is covered by a layer of the blanket member 12 material; however shown in FIG. 1 there is a partial cut away view to show individual pressure sensors 14 which as a group define the pressure sensor array 13. The pressure sensor array 13 measures pressure that may be applied at one or more location therealong. In one embodiment, the pressure sensor array 13 is in electronic communication with the control module 16 via a wire 15. This electronic communication is an analog and/or digital signal of the magnitude of pressure applied at one or more points along pressure sensor array 13. The pressure sensor array may even communicate where along the pressure sensor array 13 pressures are being applied. For example, the pressure sensor array may include a pressure sensor, such as, but not limited to a Weight Sensing Device, by Enomoto et al. U.S. Pat. No. 6,849,808, incorporated by reference herein.

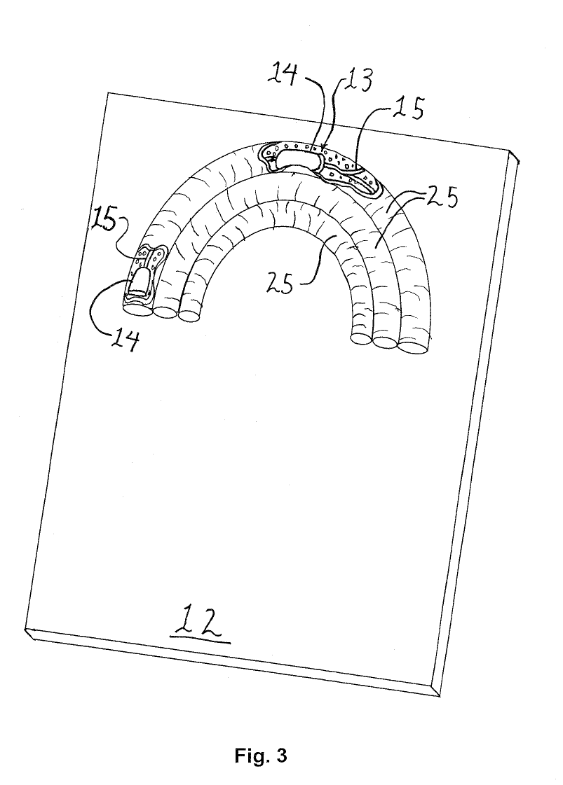

As illustrated in FIG. 3, according to one embodiment, the pressure sensor array 13 includes at least one pressure sensor disposed inside a fluid filled member 25. The fluid filled member 25 is formed in an arcuate shape protruding up or being raised so as to surround a portion of an infant disposed therebetween. Further, the pressure sensor array 13 is configured to register a pressure differential when pressure is applied anywhere upon the fluid filled member 25. As shown in FIGS. 2 and 3, in alternative embodiments, the pressure sensor array 13 may be arranged so as to have pressure sensors arranged in multiple arcs to form multiple concentric arcs proximate to each. A pressure sensor array 13 with multiple arcs conforms around infants of varying sizes and shapes. Further, the pressure sensor array 13, is shown to include material disposed around the pressure sensors 14 thereof. The material around the pressure sensors 14 has a thickness so as to define a projection that is raised and/or elevated above the portion of the blanket member 12 whereon an infant may be laid. This projection is due to the material around the pressure sensor array 13 and serves to further keep an infant in a proper position.

Further illustrated, the control module 16 is shown clearly as if it is upon the blanket member 12. However, in an alternative embodiment, the control module is disposed in between the layers of the blanket member 12, and is fixably attached thereto. The illustrated control module 16 includes a data processing module 24 for the processing of, and control of, signals from the pressure sensor array 13. The data processing module 24 is in electronic communication with the pressure sensor array 13. Further, the illustrated control module 16 includes a transceiver module 26 electronically incorporated therein for the communication of wireless signals to a relay module 20. The transceiver module 26 is in electronic communication with the data processing module 24. One example of a control module with a data processing module and transceiver module included therein in is such as, but not limited to, the Multi-mode radio frequency network system, by Palmer, et al., in U.S. Pat. No. 6,295,461, incorporated by reference herein. One further example of a data processing module includes a Method of controlling storage device controlling apparatus, and storage device controlling apparatus, by Nakayma, et al. in U.S. Pat. No. 7,240,152 incorporated by reference herein.

Additionally illustrated, the control module 16 includes an On/Off switch that may also serve as a volume control. The On/Off switch 17 is in electronic communication with the control module 16, thereby supplying power control to the module and components thereof, which may thereby be enabled or disabled according to the desire of a user. Additionally, the control module 16 includes a power module 28 which provides the requisite power to all of the components electrically attached thereto. The power module is in electric communication by wire 15 with the speaker module 18, the pressure sensor array 13, and the control module 16, including, but not limited to, the data processing module 24 and the transceiver module 26. One example of a power module is such as, but not limited to, the Electric load control device of heating device of heating blanket, by Wu, in U.S. Pat. No. 7,064,294, which incorporated by reference herein.

Also illustrated there is a relay module 20 which is structurally independent from the blanket member 12. Further, the receiver module 20 is positioned on a table 19 at a close proximity to the blanket member 12. The relay module 20 includes therein a signal receiver module 30 which captures wireless signals from the control module 16. Further, the relay module 20 includes therein a signal transceiver module 32 which relays wireless signals received from the control module 16 to a remote alert module 22. The signal receiver module 30 and the signal transceiver module 32 are in electronic communication. For example a relay module may be such as, but not limited to, the Wireless sensor and control transmitter system, by Alvarez, in U.S. Pat. No. 7,050,887, which is incorporated by reference herein.

As shown, according to one embodiment, there is a relay user interface module 34 integral to the relay module 20 for a user's electronic control of the same. Additionally, the relay module 20 includes a relay speaker module 36 for providing audio alerts. The relay speaker module is in electronic communication with the signal receiver module 30 and the signal transceiver module 32 of the relay module 20. Further, in one embodiment, there is a relay power module 38 therein, which may be such as, but not limited to, batteries, thereby enabling the electronic functions of the relay module 20. The relay power module 38 is in electric communication with the relay module 20, including, but not limited to, the signal receiver module 30, signal transceiver module 32 and relay speaker module 36. One example of a relay power module may be such as, but not limited to, an Integral Battery and Recharger, by Insley, in U.S. Pat. No. 6,913,853, which incorporated by reference herein.

In one embodiment, the speaker module 18 may be shown as if it is upon the blanket member 12. However, in an alternative embodiment, the speaker module 18 is disposed between layers of the blanket member 12 and is fixably attached thereto. In one embodiment, and as shown, the speaker module is disposed at a distal end of the blanket member 12. The speaker module is disposed close to the distal end of the blanket member 12 and is positioned oppositely from the control module 16 and the pressure sensor array 13. The speaker module is disposed at the distal end of the blanket so that sound therefrom does not startle an infant disposed on the blanket member 12. Advantageously, the speaker module may produce communications that soothe an infant but do not startle the infant. Further, the speaker module 18 is in electronic communication via a wire 15 with the control module 16.

Also shown a remote alert module 22, which is structurally independent from the blanket member 12. As illustrated, the remote alert module 22 may be disposed remotely from the blanket member 12 and the relay module 20. According to one embodiment, the remote alert module 22 has a compact shape enabling the remote alert module to be disposed in a pocket of a user. The remote alert module 22 includes therein a remote receiver module 40 which is in wireless communication with, and captures wireless signals from, the relay module 20. As shown, there is a remote user interface module 42 integral to the remote alert module 22 enabling user control of the same. One example of remote alert module is such as, but not limited to, the Nokia 6030 cellular phone, by Nokia, 6000 Connection Drive, Irving, Tex., 75039.

Additionally, the illustrated remote alert module 22 includes a remote speaker module 44 enabling audio alerts to the user. Further, there is a remote power module 46 therein, which may be such as, but not limited to, batteries, thereby enabling the electronic functions of the remote alert module 22. The remote alert module 22 further includes a recharging module 48. The recharging module 48 is designed to connect to a power source, such as, but not limited to, a wall power outlet providing AC power. The recharging module 48 is configured to convert AC power to DC power so as to charge DC batteries. The recharging module 48 is in electric communication with remote power module 46 to restore power thereto. One example of a recharging module is such as, but not limited to, an Integral Battery and Recharger, by Insley, in U.S. Pat. No. 6,913,853, which incorporated by reference herein.

The remote power module 46 is in electric communication with the remote alert module 22, including, but not limited to, the remote receiver module 40 and the remote speaker module 44. As shown, the remote alert module 22 has a retainer member 23, disposed on a back portion thereof. This retainer member 23 is configured to be clipped, hooked, snapped, magnetically fastened and/or otherwise attached to an object including, but not limited to: a belt, a pocket, a strap, a pole, a panel, a hook, a handle, a hand, a wrist, a arm, a leg, and a neck.

In operation of one embodiment of the invention, a user of the system 10 may place an infant in the supine position on the blanket member 12 such that the head and torso of the infant are disposed within an arc formed by the pressure sensor array 13, so that the head of the infant is near an apex of the arc defined by the pressure sensor array 13, and the body of the infant extends orthogonal therefrom. The user may then enable or disable the controller/receiver module 16 by actuating the On/Off switch one way or another, and the user may control the level of audio that may be emitted from the speaker module 18 through actuated the same to a desired setting. Next, the user may enable or disable the relay module 20 by actuating one of the relay user interface module 34 thereon. Then, further the user may control the level of audio that may be emitted from the relay speaker module 36 by controlling such through the relay user interface module 34. The user may then select the desired mode of operation of the relay module 20. The relay module 20 has a plurality of selectable modes, which may include, but are not limited to: proximate-alarm only, proximate-alarm/remote-relay, and remote-relay only. Additionally, the user may also adjust the volume of the proximate alarm of the relay module 20 if selected; as suggested earlier.

In further operation of one embodiment of the invention, the user may enable or disable a remote alert module 22 through the remote user interface module 42 thereof. The remote alert module 22 may have a plurality of selectable modes including, but not limited to: audio-alarm only, audio-alarm/vibration, and vibration only. It is envisioned that there may be a plurality of audio alarm tones that may be chosen by the user, and that the user may decide to only have an audio alarm provide an alert. In one embodiment, there is a vibrating module 50 which may be such as, but not limited to, a rotatable offset weight motivated by an electric motor. Further, in one embodiment the vibrating module 50 is disposed within the remote alert module 22. One non-limiting example of a device having a vibratory alert module therein is the Nokia 6030 cellular phone, by Nokia, 6000 Connection Drive, Irving, Tex., 75039. One further non-limiting example is the wireless mobile communication device having a speaker vibration alert and method of using the same, by Hugunin in U.S. Pat. No. 7,245,891 which incorporated by reference herein. Additionally, the user may adjust the volume of the audio-alarm as selectably desired by actuating the remote user interface module 42 thereof. Also, a user may clip, fasten and/or otherwise affix using the retainer member 23 of the remote alert module 22 to their person and/or any other object that the user may be proximate to, so as to safely store and/or stow the remote alert module 22.

In operation of one embodiment of the intention, an infant's 11 head is placed on a blanket member 12 so the infant's head is encompassed by a pressure sensor array 13 at the left, right, and top sides thereof. If an infant moves such that the head rolls to one side or the other the face of the infant makes contact with the pressure sensor array 13. When the infants face makes contact with the pressure sensor array 13 a characteristic signal is sent from the pressure sensor array 13, to the control module 16 indicating that the infant may be in an undesirable position. When such occurs, the signal is sent to a relay module 20, which may also relay a wireless signal to a remote alert module 22, and alert the user via an auditory alarm and/or vibration. Additionally, in one embodiment the control module 16 may also send electronic communication to the speaker module 18 so as to activate the same to provide music or other audible modulation to the infant, which may arouse and/or soothe the infant and cause the infant to move to a desirable position.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the blanket member 12 appears in the figures to be a certain thickness and size relative to the other components of the infant monitoring system 10, such is indicative of one embodiment. It is envisioned that the blanket member 12 may be any size, shape, or have any desirable designs, logos, indicia, etc thereon. Additionally, although the figures illustrate one speaker module 18 incorporated into the blanket member 12, it is envisioned that there may be a plurality of speaker mmodules 18, or speakers, of uniform or varying sizes therein.

Moreover, while the figures illustrate that the pressure sensing array 13 is semicircular in shape, it is envisioned that other shapes and sizes may be formed by the sensor array and still perform the intended function of the invention. For example, the pressure sensing array may have a curved shape to resemble top half of a body outline or a curved outline resembling a head portion extending to an outline of shoulders then down on both sides to resemble an external outline of arms at the sides. Furthermore, although a number of individual pressure sensors 14 are shown in the figure, it is envisioned that any number of individual pressure sensors 14 may be used to perform the function established for the pressure sensor array 13. For example, there may be one pressure sensor disposed at one end of an arc shaped member filled with fluid. Such a design would register a pressure differential when contact is made with any part of the fluid filled member wherein the pressure sensor in contained. One non-limiting example of such a pressure sensing system includes U.S. Pat. No. 6,927,678 by Fultz, et al. which discloses a fluid filled seat bladder with capacitive sensors for occupant classification and weight estimation, and which is incorporated by reference herein.

Further, it is envisioned in an alternative embodiment that, there may be a multiplicity of pressure sensor arrays 13. For example there may be a multiplicity of pressure sensor arrays 13 disposed in concentric arcs proximate to adjacent arrays, much like a rainbow of pressure sensor arrays 13. The benefit of such would be that infants of a wide range of sizes may be able to be monitored on the same blanket member 12. In operation of one embodiment of the invention, an infant 11 may be placed on the blanket member 12 of the infant monitoring system 10, whereupon doing so the user may equalize the pressure sensors array in contact with the infant, thereby indicating that the infant is in a neutral position. When the infant 11 rolls to one side or the other, the pressures sensor array just beyond the neutralized arrays signal to activate an alarm indicating that the infant 11 has moved to an undesirable position.

It is further envisioned that the relay module 20 may be powered via a power cord removably attached to an AC power outlet. Similarly, it is envisioned that the control module 16 may be powered via a power cord removably attached to an AC power outlet. Additionally, it is envisioned that the power units used in the control module 16, the relay module 20 and/or the remote alert module 22 may be comprised of, but are not limited to: lithium ion, nickel-metal-hydride, nickel-cadmium, and/or carbon-zinc type batteries.

It is expected that there may be numerous variations of the design of this invention. For example, the relay module 20 may be incorporated into the blanket member 12 rather than being a standalone module of the infant monitoring system 10. In addition, there may also be a plurality of remote alert modules 22 that may be used. Too, the control module 16 may be disposed outside of the blanket member 12, not fixably attached therein. Similarly, the speaker module 18 may be disposed outside of the blanket member 12, not fixably attached therein.

Finally, it is envisioned that the components of the device may be constructed of any of a variety of materials, such as metals, including, but not limited to: aluminum, steel, iron, silver, gold, copper, tin, and/or titanium; plastics, including, but not limited to: polyvinyl-chloride, polyester, polypropylene, polyethylene, low density polycarbonate, acrylic, nylon, spandex, rayon, PET, and/or PETE; various ceramics; various organics, including, but not limited to: cotton, wool, alpaca, hemp, and/or silk; and/or composites thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An infant monitoring system, comprising:
a) a blanket member having:
i) a pressure sensor array in an arcuate shape, disposed interior to the blanket member, configured to measure and communicate pressure measurements;
ii) a speaker module, configured to emit audio communication;
iii) a control module, in electronic communication with the pressure sensor array, and the speaker module, and configured to control the relay of electronic and wireless signals therefrom;
b) a remote alert module, configured to provide audio and vibratory alerts; and
c) a relay module, in wireless communication with the control module and the remote alert module, disposed proximate to the blanket member and configured to receive and send wireless communication with other modules as well as relay audio alerts to a user.

2. The infant monitoring system of claim 1, wherein the blanket member is comprised of multiple layers wherebetween the pressure sensor array is disposed.

3. The infant monitoring system of claim 1, wherein the pressure sensor array includes at least one pressure sensor disposed in a fluid filled member so that a pressure differential may be registered when pressure is applied anywhere upon the fluid filled member.

4. The infant monitoring system of claim 1, wherein there is a multiplicity of pressure sensor arrays disposed interior to the blanket member, wherein the multiplicity of pressure sensor arrays are formed in concentric arcuate shapes proximate to each other.

5. The infant monitoring system of claim 1, wherein the arcuate shape formed by the pressure sensor array is curved so as to define the form of a top half of a body outline.

6. The infant monitoring system of claim 1 wherein the pressure sensor array has a material disposed around it so as to form a semi-tubular shape, wherein the semi-tubular shape serves to further keep an infant in a proper position.

7. The infant monitoring system of claim 1, wherein the control module further includes:
an On/Off switch;
a data processing module configured to process signals received from the pressure sensor array;
a transceiver module configured to send wireless signals to the relay module; and
a power module configured to provide power to all components requiring power which are in electric communication with the control module.

8. The infant monitoring system of claim 1, wherein the relay module further includes a relay speaker module configured to communicate audio messages to a user.

9. The infant monitoring system of claim 1, wherein the remote alert module further includes a vibrating module, configured to communicate a vibratory alert to a user.

10. The infant monitoring system of claim 1, wherein the remote alert module further includes a remote speaker module configured to communicate an audio message to a user.

11. The power module of claim 3, further comprises a power cord for connecting to a power source which may include a power outlet.

12. The infant monitoring system of claim 1, wherein the remote alert module further includes a remote power module in electric communication therewith configured to power the remote alert module.

13. The remote power module of claim 8, further includes a least one battery wherein the battery is rechargeable by a recharging module.

14. An infant monitoring system, comprising:
a) a blanket member, having a multi-layer construction, wherein edges of the multi-layers are coupled to other edges to hold the blanket member together, wherein the blanket member further includes:
i) a pressure sensor array arranged in an arched shape so as to define a silhouette of an upper portion of a human body outline, disposed near a proximal end of the blanket member, and configured to measure and communicate pressure measurements at one or more locations along the arrangement thereof;
ii) a speaker module, disposed interior to and near a distal end of the blanket member, and configured to send out audio communication;
iii) a control module, in electronic communication with the pressure sensor array, and the speaker module, and configured to control the relay of electronic and wireless signals therefrom;
b) a remote alert module, having a compact shape, able to be disposed in a pocket of a user, and configured to provide audio and vibratory alerts to a user; and
c) a relay module, in wireless communication with the control module and the remote alert module, disposed proximate to the blanket member and configured to receive and send wireless communication with other module as well as relay audio alerts to a user.

15. The infant monitoring system of claim 14, wherein the pressure sensor array includes at least one pressure sensor disposed in a fluid filled member, wherein the fluid filled member is formed in an arcuate shape to surround a portion of an infant disposed therebetween, and being configured to register a pressure differential when pressure is applied anywhere upon the fluid filled member.

16. The infant monitoring system of claim 14, wherein the pressure sensor array includes pressure sensors arranged in multiple arcs to form concentric arcs proximate to each other so as to conform around infants of varying sizes and shapes.

17. The infant monitoring system of claim 14, wherein the pressure sensor array includes material disposed around pressure sensors thereof, having a thickness that defines a projection which serves to further keep an infant in a proper position.

18. The infant monitoring system of claim 14, wherein the remote alert module further includes a retainer member, disposed on a back portion thereof, configured to be clipped, hooked, snapped, magnetically fastened and otherwise attached to an object including but not limited to a belt, pocket, strap, pole, panel, hook, handle, hand, wrist, arm, leg, and neck.
